(19) United States
(12) Patent Application Publication
(10) Pub. No.: US 2015/0180872 A1
(43) Pub. Date: Jun. 25, 2015

(54) SYSTEM AND METHOD FOR HIERARCHICAL RESOURCE PERMISSIONS AND ROLE MANAGEMENT IN A MULTITENANT ENVIRONMENT

(71) Applicant: Cube, Co., Mountain View, CA (US)

(72) Inventor: Joel Christner, Mountain View, CA (US)

(73) Assignee: Cube, Co., Mountain View, CA (US)

(21) Appl. No.: 14/136,588

(22) Filed: Dec. 20, 2013

(51) Int. Cl. H04L 29/06

(52) U.S. Cl. CPC H04L 63/10

(57) ABSTRACT

A system and method is provided for managing roles-based access to resources arranged in a hierarchy. A hierarchical roles-based access control system receives a request from a user to access a particular resource. The system identifies a set of permissions for the user based on user identification information provided with the request. Specifically, each permission in the set is associated with a respective resource and one or more actions that the user is authorized to perform on that resource. The system then determines a hierarchical lineage for the particular resource in relation to each resource associated with the set of permissions, and determines whether the user is authorized to access the particular resource based, at least in part, on the hierarchical lineage.

### TECHNICAL FIELD

Examples described herein relate to resource management, and more specifically, to managing role-based access to resources in a multitenant environment.

### BACKGROUND

Resources (e.g., data) stored in a network environment may be made accessible to many users. However, the particular type of access may vary depending on the user. For example, the creator of a web page or “blog” may have permission to view and/or edit the contents of her blog, whereas her audience (e.g., a casual browser of the blog) may only have permission to view it. A user desiring to access a particular resource transmits a request to a “gatekeeper,” which manages access to the system's resources. The request typically includes a user identifier (e.g., creator or casual browser), a resource identifier (e.g., storage location or file-path), and a desired action (e.g. view or edit). The gatekeeper analyzes the request and determines whether or not the user is authorized to perform the desired action on the particular resource. For example, if the gatekeeper receives a request from the creator to add a new entry to her blog, the gatekeeper may search a permissions list to identify a set of permissions associated with her user identifier to determine whether or not she is authorized to create a new entry under the identified resource.

Under conventional implementations, a set of permissions for a particular user includes an individual permission for every action associated with every resource. For example, the creator of the blog will have a permission to write data to her blog and a separate permission to view data from her blog. However, if the creator of the blog wishes to allow her friend to create new entries in her blog, a duplicate set of permissions is typically created for the friend. If the blog later morphs into a successful e-commerce website the creator may wish to give similar access rights to all of her employees. Accordingly, the list of permissions may need to be updated each time a new employee is added and/or removed from the company.

The need to constantly update the permissions list may become a limiting factor when designing systems wherein a particular user is to be given access to multiple resources and/or multiple users are to be provided access to the same resource. This is particularly problematic in the context of online banking, wherein a user may wish to create multiple accounts with the same bank and/or add additional users (e.g., spouse, children, business partners, employees, etc.) to an existing bank account.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

A system and method of operation are disclosed that may aid in role-based access to hierarchical resources. A hierarchical roles-based access control system receives a request from a user to access a particular resource. The system identifies a set of permissions for the user based on user identification information provided with the request. Specifically, each permission in the set is associated with a respective resource and one or more actions that the user is authorized to perform on that resource. For some embodiments, the set of permissions may be mapped to multiple users. The system then determines a hierarchical lineage for the particular resource in relation to each resource associated with the set of permissions, and determines whether the user is authorized to access the particular resource based, at least in part, on the hierarchical lineage. For example, the user may be denied access to the particular resource if none of the resources associated with the set of permissions fall within the hierarchical lineage.

The request further specifies a desired action to be performed on the particular resource. For some embodiments, the system may determine whether the user is authorized to perform the desired action on the particular resource. The system may thus enable the user to access the particular resource upon determining that the user is authorized to perform the desired action on the particular resource. For other embodiments, the system may determine whether the user is authorized to perform the desired action on a parent resource, wherein the parent resource falls within the hierarchical lineage of the particular resource and belongs to a higher level of the hierarchy than the particular resource. The system may further enable the user to access the particular resource upon determining that the user is authorized to perform the desired action on the parent resource.

The user identification information may include a user identifier, a subtenant identifier, and/or a tenant identifier. For some embodiments, the system may identify a first set of permissions based on the user identifier. If none of the resources associated with the first set of permissions fall within the hierarchical lineage, the system may then identify a second set of permission based on the subtenant identifier. If none of the resources associated with the first or second sets of permissions fall within the hierarchical lineage, the system may further identify a third set of permissions based on the tenant identifier.

Providing hierarchical-access to resources allows multiple users to be associated with the same set of permissions (e.g., through “role” assignments), which may reduce and/or eliminate redundancies in the list of permissions maintained by a gatekeeper. Specifically, individual users may be given more generic and/or restrictive access to resources in the database depending on their assigned roles. For example, a user that is given specific access to a parent resource is also authorized to have similar access to any resources below the parent in a hierarchical lineage. Furthermore, by providing roles-based access to resources, users may be added to and/or removed from a set of permissions with little or no modification to the list of permissions maintained by the gatekeeper.

### BRIEF DESCRIPTION OF THE DRAWINGS

The present embodiments are illustrated by way of example and are not intended to be limited by the figures of the accompanying drawings where:

FIG. 1 illustrates a system for providing access to resources arranged in a hierarchy, in accordance with some embodiments;

FIG. 2 shows an exemplary set of resources that are arranged in a hierarchy;

FIG. 3 is a block diagram of a resource access request in accordance with some embodiments;

FIG. 4 shows an exemplary resource identifier that may be used to specify a particular resource in a hierarchy;

FIG. 5 is a block diagram that illustrates a hierarchical roles-based access controller in accordance with some embodiments;

FIG. 6 is an illustrative flow chart depicting a hierarchical roles-based resource access operation in accordance with some embodiments;

FIG. 7 is an illustrative flow chart depicting a hierarchical roles-based resource access operation in accordance with other embodiments; and

FIG. 8 is a block diagram that illustrates a computer system upon which embodiments described herein may be implemented.

### DETAILED DESCRIPTION

In the following description, numerous specific details are set forth such as examples of specific components, circuits, and/or processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

Examples described herein provide a system and method for managing role-based access to resources in a multitenant environment. According to some embodiments, a hierarchical roles-based access control system receives a request from a user to access a particular resource. The request includes user identification information and information specifying a desired action to be performed on the particular resource. The system identifies a set of permissions for the user based on user identification, wherein each permission in the set is associated with a respective resource and one or more actions that the user is authorized to perform on that resource. The system then determines a hierarchical lineage for the particular resource in relation to each resource associated with the set of permissions, and determines whether the user is authorized to perform the desired action on the particular resource based, at least in part, on the hierarchical lineage.

Among other benefits, examples described herein recognize that the accessibility of a particular resource or set of resources may be constantly changing in multitenant environments. For example, a merchant (e.g., company or business owner) may wish to authorize its employees to access one or more merchant bank accounts. Moreover, the merchant may authorize certain employees (e.g., directors, partners, regional managers, etc.) to have access to multiple accounts (e.g., for multiple store locations), while restricting the access of other employees (e.g., cashiers, salespeople, store managers, etc.) to a single account (e.g., for a particular store location). Thus, the permissions associated with each account may constantly evolve as employees are added and/or removed from the company, and as accounts are activated and/or deactivated with the bank. Under conventional implementations, one or more permissions are created each time a new resource is added to the system (i.e., for each user and/or group of users having access to that resource).

However, examples herein recognize that constantly updating the permissions list is often impractical and/or inefficient. For example, because a user may not access an account until given specific permission to do so by the permissions list, under conventional implementations, it may be difficult, if not impossible, to create new merchant accounts on-the-fly. Therefore, examples herein provide a mechanism for enabling access to resources in a hierarchical manner, wherein permissions may be assigned as a degree of specificity of a user's “role.” Thus, a user having a more “generic” permission (e.g., corresponding to a regional manager role) is programmatically authorized to access any resources that are more specific to that user's role (e.g., all merchant accounts associated with a particular region), even if such accounts did not exist at the time the permission was created.

Examples described herein also recognize that systems often employ multiple resource databases, each of which is formatted and/or accessed in a different manner. For example, the same bank may store some account data in a Windows-based server while storing other account data in a Unix-based server. Thus, under conventional implementations, a separate application programming interface (API), and corresponding permissions list, is provided for each server. However, by assigning permissions as a degree of specificity of a user's role, the examples herein also provide a mechanism which may unify access to resources stored across different operating systems. As a result, any of the system's resources may be accessible via a single API.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Architecture

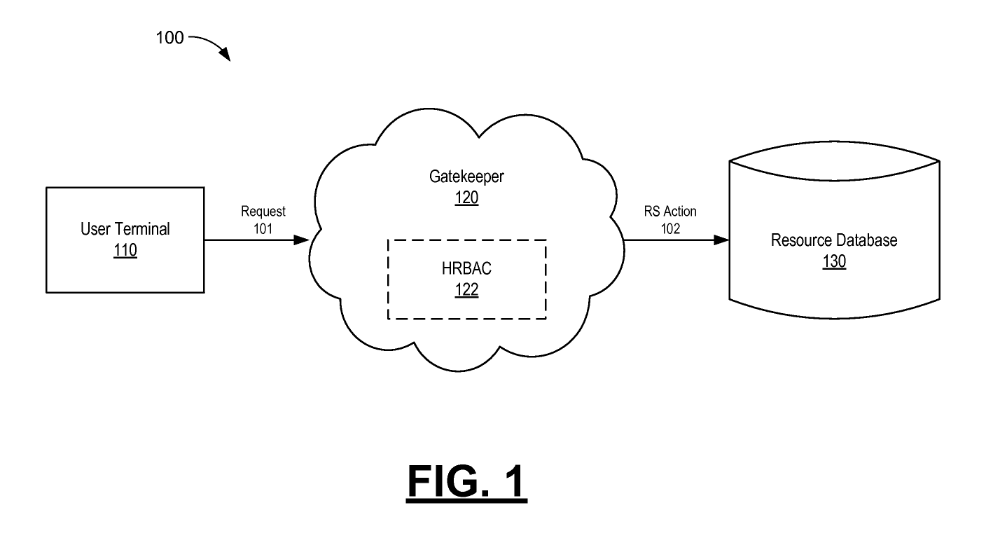

FIG. 1 illustrates a system 100 for providing access to resources arranged in a hierarchy, in accordance with some embodiments. The system includes a user terminal 110, a gatekeeper 120, and a resource database 130. The user terminal 110 may correspond to a desktop computer, laptop, tablet, smartphone, PDA, and/or any other personal computing device capable of communicating with the gatekeeper 120 (e.g., via the Internet). The gatekeeper 120 controls (e.g., allows and/or denies) access to resources stored in the resource database 130. For some embodiments, the gatekeeper 120 may control access to a number of resource databases (not shown for simplicity). The resource database 130 stores resources (e.g., data, records, files, etc.) that may be individually accessed and/or acted upon by a user. For some embodiments, the resources stored in the resource database 130 may be arranged (i.e., accessed) in a hierarchical manner.

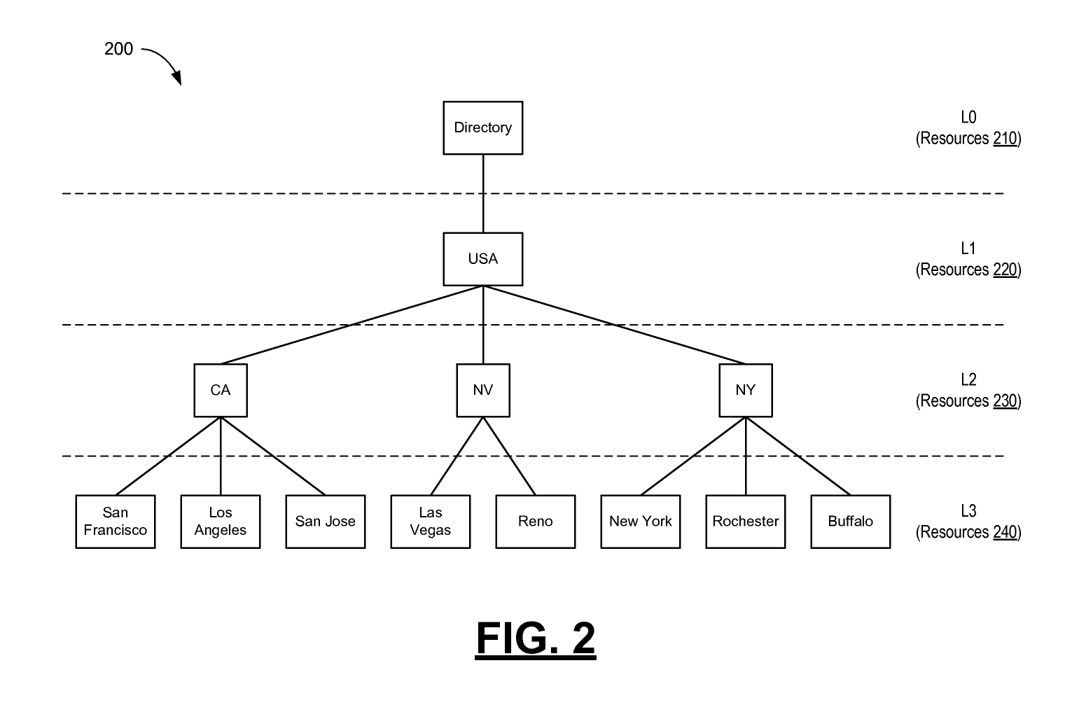

FIG. 2 shows an exemplary set of resources that are arranged in a hierarchy 200. Specifically, the hierarchy 200 (or “hierarchical tree”) includes four subsets of resources 210-240 that are stored across four hierarchical levels L0-L3, respectively. The subset of resources 210 associated with the highest level of the hierarchy (L0) includes the resource “Directory.” The subset of resources 220 associated with the second-highest level of the hierarchy (L1) includes the resource “USA.” The subset of resources 230 associated with the third-highest level of the hierarchy (L2) includes the resources “CA,” “NV,” and “NY.” Finally, the subset of resources 240 associated with the bottom level of the hierarchy (L3) includes the resources “San Francisco,” “Los Angeles,” “San Jose,” “Las Vegas,” “Reno,” “New York,” “Rochester,” and “Buffalo.” It should be noted that the hierarchy 200 may contain fewer or more levels in other embodiments. Similarly, each level of the hierarchy 200 may include fewer or more resources than those depicted in FIG. 2.

A “hierarchical lineage” refers to any number of resources that are connected to one another by one or more edges in the hierarchy 200. More specifically, a hierarchical lineage spans multiple hierarchical levels (e.g., L0-L3) and may include, at most, one resource from each level or subset of resources (e.g., 210-240). For example, “Directory,” “USA,” “CA,” and “San Francisco” may form a hierarchical lineage, whereas “Directory,” “USA,” “CA,” “San Francisco,” and “Los Angeles” would not. In the latter case, both “San Francisco” and “Los Angeles” belong to the subset of resources 240 and therefore cannot be part of the same hierarchical lineage. In another example, “Directory,” “USA,” “CA,” and “New York” would not form a hierarchical lineage because there is no edge connecting “New York” to either “CA,” “USA,” or “Directory.”

As used herein, the term “parent resource” refers to any resource that is associated with a higher hierarchical level than a particular resource in a hierarchical lineage. For example, “Directory” and “USA” are both parent resources of “San Francisco.” Furthermore, “CA” is also parent resource of “San Francisco,” however “NV” and “NY” are not. In the latter case, even though “NV” and “NY” belong to higher levels (L2) of the hierarchy 200 they do not belong to any hierarchical lineage that would include “San Francisco.” The term “child resource” refers to any resource that is associated with a lower hierarchical level than a particular resource in a hierarchical lineage. For example, “San Francisco” and “New York” are both child resources of “Directory” and “USA.” Furthermore, “San Francisco” is a child resource of “CA” whereas “New York” is not. As described above, “New York” is not a child resource of “CA” because it does not belong to any hierarchical linage that would include “CA.”

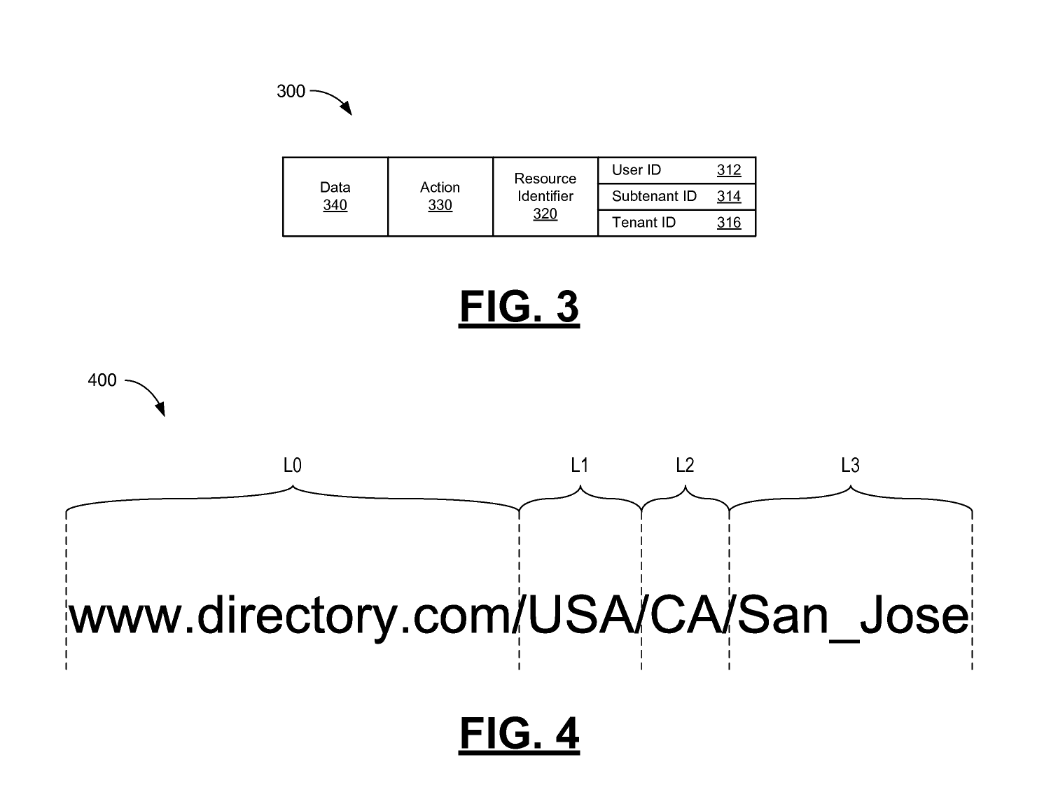

Referring back to FIG. 1, a user may access any of the resources stored in the resource database 130 by transmitting a resource access request 101 to the gatekeeper 120. As shown in FIG. 3, a resource access request 300 may include a user identifier (user ID) 312, a subtenant identifier (subtenant ID) 314, a tenant identifier (tenant ID) 316, a resource identifier 320, and an action 330 to be performed on the identified resource. The user ID 312 includes information identifying a specific “role” associated with the user. For example, the user ID 312 may identify the particular user that initiated the request (e.g., “John Doe”). The subtenant ID 314 includes information identifying a more generic role associated with the user. For example, the subtenant ID 314 may specify the user's job description (e.g., “CEO,” “manager,” “employee,” etc.). The tenant ID 316 includes information identifying the user's role with an even higher level of abstraction. For example, the tenant ID 316 may specify the company or business to which the user belongs (e.g., “Cube,” “Starbucks,” “Wal-Mart,” etc.).

The resource identifier 320 specifies a particular resource that the user is requesting access to. For some embodiments, the resource identifier 320 may correspond to a uniform resource identifier (URI). FIG. 4 shows an exemplary resource identifier 400 that may be used to specify a particular resource in a hierarchy. In the example shown, the requested resource is “San Jose,” which is located in the fourth level (L3) of the hierarchy (e.g., hierarchy 200 shown in FIG. 2). It should be noted that the resource identifier 400 also specifies the path for tracing and/or locating the desired resource in the hierarchy (e.g., L0: “Directory”→L1: “USA”→L2: “CA”→L3: “San Jose”). For some embodiments, the path specified by the resource identifier 400 may represent (at least part of) a hierarchical lineage for the requested resource. It should be noted, however, that the resource identifier 400 may specify any resource at any level of the hierarchy. For example, the resource identifier 400 may specify “CA” as the desired resource even though “CA” has multiple child resources (e.g., “San Francisco,” “Los Angeles,” and “San Jose”).

The action 330 indicates the particular type of access or action to be performed on the desired resource (i.e., specified by the resource identifier 320). Actions 330 may include, for example: POST, PUT, GET, and/or DELETE. The POST command may be used to create a new entry under the specified resource. The DELETE command may be used to delete the specified resource. The GET command may be used to retrieve and/or search the specified resource for one or more data items. The PUT command may be used to perform a number of actions including, but not limited to: executing instructions associated with the specified resource; updating the information stored with specified resource; creating a new entry under the specified resource; and/or searching the specified resource for one or more data items. For some embodiments, the resource access request 300 may also include data 340 associated with the action 330. For example, if the user requests to POST a new entry under the specified resource, the data 340 may correspond to the data to be posted or included with the new entry.

Referring back to FIG. 1, the gatekeeper 120 receives the resource access request 101 and determines whether the user is authorized to perform the requested action (e.g., action 330) on the specified resource (e.g., resource identifier 320). For some embodiments, the gatekeeper 120 makes this determination by searching a hierarchical roles-based access controller (HRBAC) 122. As described in greater detail below, the HRBAC 122 may map a set of permissions to a particular user role. Each permission is associated with a particular resource in the database 130 and includes one or more actions that the user (associated with the corresponding user role) is authorized to perform on that resource. Thus, upon receiving a resource access request 101, the gatekeeper 120 may first search a set of permissions associated with the user ID 312 in order to identify a permission which authorizes the user to perform the requested action (e.g., action 330) on the specified resource (e.g., resource identifier 320). For some embodiments, the gatekeeper 120 may enable the user to perform a more specific action if the user is given a more “generic” permission (i.e., if the user is authorized to perform the requested action on a parent resource).

For example, with reference to FIG. 2, a user may wish to GET data from the resource “San Francisco,” but may not have a permission specifically authorizing the user to perform such action with respect to “San Francisco.” The gatekeeper 120 may then determine whether the user is authorized to perform a GET operation with respect to “CA,” “USA,” and/or “Directory” (i.e., the parent resources of “San Francisco”). Accordingly, the gatekeeper 120 may still enable the user to perform the GET operation on “San Francisco” if the user is authorized to perform the same (or similar) action with respect to at least one parent resource.

For some embodiments, if the gatekeeper 120 is unable to find a permission authorizing the user to perform the requested action on the specified resource (or a more generic permission) based on the user ID 312, the gatekeeper 120 may then search a set of permissions associated with the subtenant ID 314 for authorization. For example, a merchant may authorize all of its managers to access a particular merchant bank account. Thus, even though John Doe may not have individual access to this account, he may be authorized to access the account based on his role as a manager. Lastly, if the gatekeeper 120 is unable to find a permission authorizing the user to perform the requested action on the specified resource (or a more generic permission) based on the subtenant ID 314, the gatekeeper 120 may then search a set of permissions associated with the tenant ID 316 for authorization. For example, all employees associated with a merchant may be authorized to have a particular type of access (e.g., to deposit money) to a merchant account.

Upon determining that the user is authorized to perform the requested action on the desired resource, the gatekeeper 120 may send a resource-specific (RS) action 102 to the database 130. For example, the RS action 102 may include the resource identifier 320, the action 330 to be performed, and/or data 340 associated with the action, as described above with respect to FIG. 3. If the user is not authorized to perform the requested action on the desired resource based on the user ID 312, subtenant ID 314, or tenant ID 316, the gatekeeper 120 may return a message to the user terminal 110 indicating that the user is not authorized to perform the requested action.

As described above, the gatekeeper 120 may allow multiple users to be associated with the same set of permissions (e.g., through “role” assignments), which may reduce and/or eliminate redundancies in the list of permissions maintained by the HRBAC 122. Furthermore, individual users may be given more generic and/or restrictive access to resources in the database depending on their assigned roles, which may allow users to access newly-created resources without having to create a new set of permissions. Furthermore, by providing roles-based access to resources, users may be added to and/or removed from a set of permissions with little or no modification to the list of permissions maintained by the gatekeeper 120.

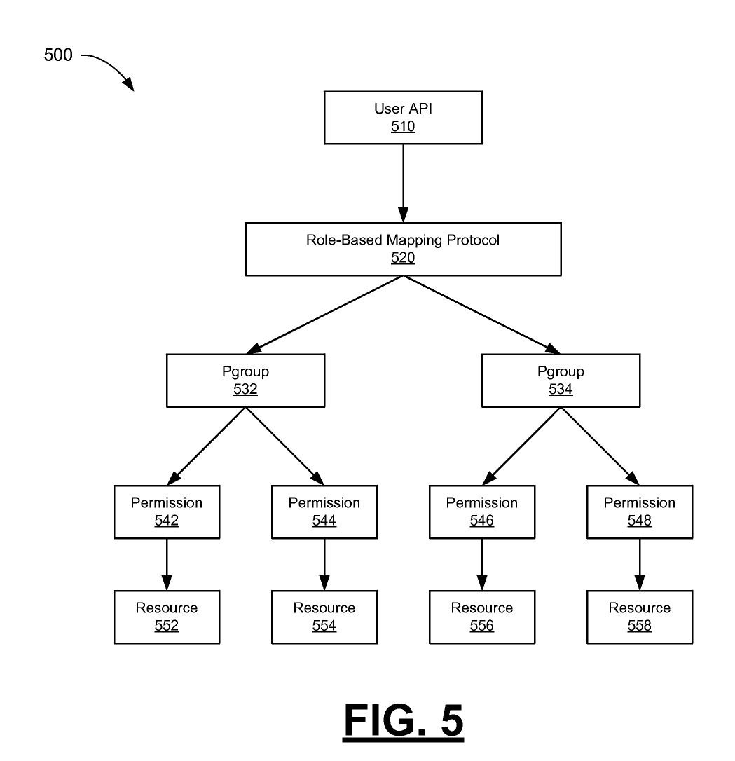

FIG. 5 is a block diagram that illustrates a hierarchical roles-based access controller (HRBAC) 500 in accordance with some embodiments. The HRBAC 500 includes a user application programming interface (API) 510, a role-based mapping protocol (RBMP) 520, a set of permissions groups (Pgroups) 532-534, a number of permissions 542-548, and a corresponding number of resources 552-558. The user API 510 parses a resource access request received by the HRBAC 500 and forwards the information to the RBMP 520. For some embodiments, the HRBAC 500 may control access to multiple resource databases running different operating systems. Thus, the HRBAC 500 may receive resource access requests with differently-formatted resource identifiers and/or actions. For some embodiments, the user API 510 may modify the information included with each resource access request to cohere with a uniform standard that may be interpreted by the HRBAC 500.

The RBMP 520 maps the user identification information (e.g., user ID 312, subtenant ID 314, and/or tenant ID 316) provided with the request to a particular Pgroup 532 or 534. It should be noted that each Pgroup is associated with a particular role or individual. However, in other embodiments, the HRBAC 500 may include fewer or more Pgroups than those depicted in FIG. 5 (e.g., depending on the number of users and/or roles for which access to resources is defined).

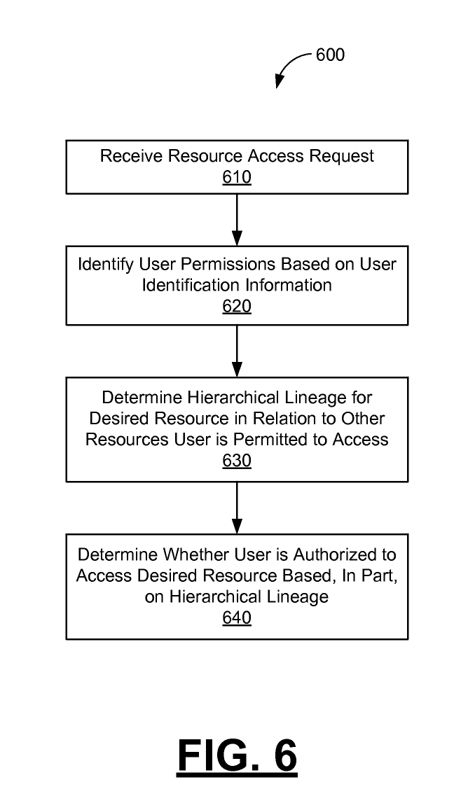

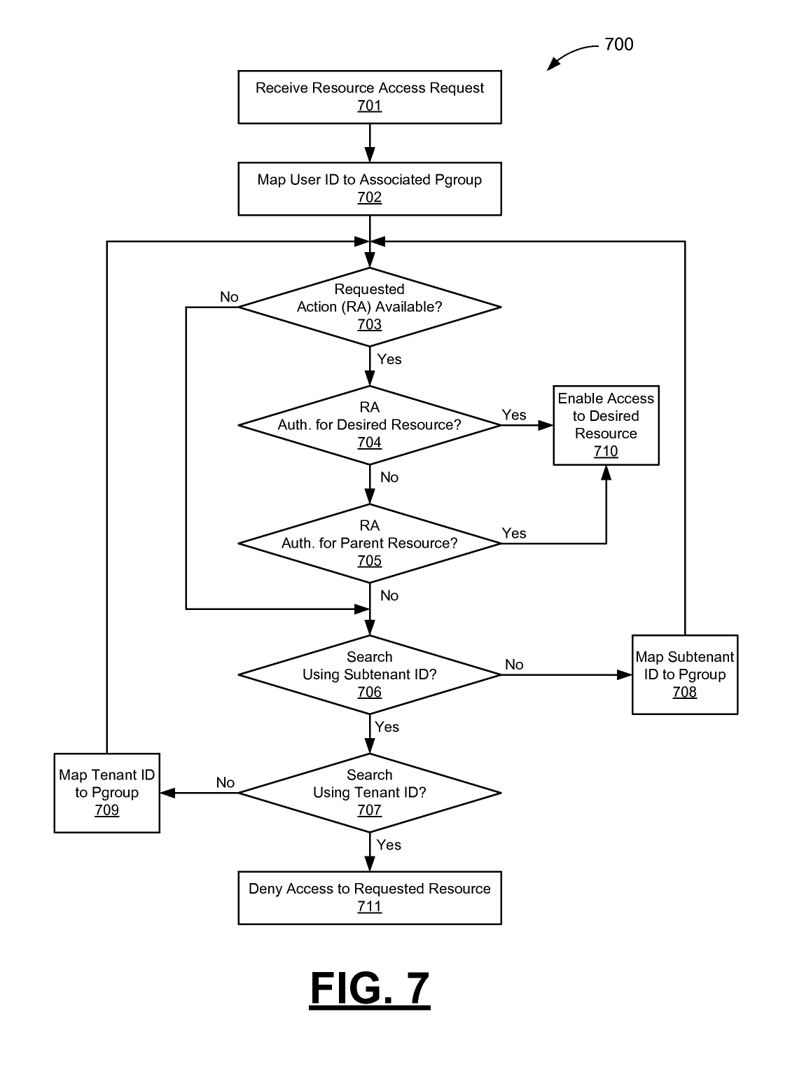

Each Pgroup 532 and 534 is associated with a set of permissions 542-544 and 546-548, respectively. Each of the permissions 542-548 specifies a number of actions that the associated user or role is authorized to perform on a corresponding resource (e.g., resources 552-558, respectively). For example, the Pgroup 532 may be associated with the role of “manager,” and permission 542 may include POST and GET operations and resource 552 may correspond to “San Jose,” whereas permission 544 may include PUT and DELETE operations and resource 554 may correspond to “Las Vegas.” Thus, any user identified as a “manager” by the RBMP 520 may be authorized to create and/or read data from the resource “San Jose,” as well as update and/or delete data from the resource “Las Vegas.” A more detailed operation of the HRBAC 500 is described below, with reference to FIGS. 6 and 7.

Methodology

FIGS. 6 and 7 are illustrative flow charts depicting hierarchical roles-based access operations in accordance with some embodiments. Methods such as described by examples of FIGS. 6 and 7 may be implemented using, for example, a system such as described with respect to FIGS. 1-5. Accordingly, reference may be made to elements of FIGS. 1-5 for purpose of illustrating suitable components for performing a step or sub-step being described.

With respect to the hierarchical roles-based resource access operation 600 depicted in FIG. 6, the gatekeeper 120 first receives a resource access request 101 from a user (610). As described above with respect to FIG. 3, the resource access request may include user identification information (e.g., user ID 312, subtenant ID 314, and tenant ID 316), a resource identifier 320, an action 330 to be performed on the identified resource, and/or data 340 associated with the action 330.

The gatekeeper 120 then identifies a set of user permissions based on the user identification information (620). For some embodiments, the gatekeeper 120 may search the HRBAC 122 for a set of permissions associated with the user ID 312, subtenant ID 314, and/or tenant ID 316 (e.g., in that order). As described above, with reference to FIG. 5, each set of permissions (e.g., Pgroups 532-534) stored in the HRBAC 122 may be associated with a particular role, which is indicated by the user identification information (e.g., user ID 312, subtenant ID 314, and/or tenant ID 316). Furthermore, each of the permissions (e.g., permissions 542-548) specifies a number of actions that the associated user or role is authorized to perform on a corresponding resource (e.g., resources 552-558, respectively).

Based on the identified permissions, the gatekeeper 120 may determine a hierarchical linage for the desired resource in relation to other resources the user is permitted to access (630). As described above, with reference to FIG. 2, a hierarchical lineage refers to any number of resources that are connected to one another by one or more edges in a hierarchy, including, at most, one resource from each level of the hierarchy. For some embodiments, the hierarchical lineage may include only the desired resource and/or one or more parent resources of the requested resource. On the other hand, the hierarchical lineage may be empty (i.e., includes only the null set) if none of the resources associated with the set of permissions identified for the user include, or are parent resources of, the desired resource. For example, if a user requests to access to the resource “San Francisco,” and the set of permissions for the user includes the resources “Directory,” “USA,” and “NV,” only “Directory” and “USA” are included in the hierarchical lineage for “San Francisco.” However, if a user requests access to the resource “San Francisco,” and the set of permissions for the user includes only the resources “NV” and “NY,” no resources are included in the hierarchical lineage for “San Francisco” (i.e., the hierarchical lineage includes only the null set).

Finally, the gatekeeper 120 determines whether the user is authorized to access the desired resource based, at least in part, on the hierarchical lineage (640). For some embodiments, the user may be authorized to access the desired resource if the user has a permission specifically for that resource and/or a more generic permission that includes the desired resource (e.g., a permission associated with a parent resource). For example, if a user requests access to the resource “San Francisco,” and the set of permissions for the user includes the resources “Directory,” “USA,” and “NV,” the gatekeeper 120 may determine that the user is authorized to access “San Francisco” based on the permissions associated with either “Directory” and/or “USA.” However, if the user requests access to the resource “CA,” but the set of permissions for the user includes only the resources “NV” and “Los Angeles,” the gatekeeper 120 may determine that the user is not authorized to access “CA.” Thus, even though “Los Angeles” falls within a hierarchical lineage of “CA,” it is not a parent resource of “CA” and therefore any permission associated with “Los Angeles” is not generic to “CA.”

For some embodiments, the user will be authorized to access the desired resource only if the requested action to be performed on that resource matches one or more actions included with a permission for that resource (or a parent resource). For example, if the user requests to POST data to “San Francisco,” but only has permissions to GET data from “Directory” and “USA,” the user will be denied access to POST the data to “San Francisco.” However, if the user requests to POST data to “San Francisco,” while having permissions to GET data from “USA” and to GET or POST data to “Directory,” the user may be authorized to POST the data to “San Francisco” based on the permission to POST data to “Directory” (which is a parent resource of “San Francisco”). For some embodiments, the gatekeeper 120 may determine authorization for the user based on the most “specific” (or least generic) permission that authorizes the requested action for the desired resource. For example, the gatekeeper 120 may determine whether the user is authorized to POST data to “San Francisco” by first searching for a POST permission associated with “USA” before searching for a POST permission associated with “Directory.”

FIG. 7 is an illustrative flow chart depicting a hierarchical roles-based resource access operation 700 in accordance with other embodiments. With reference, for example, to FIG. 5, the HRBAC 500 receives a resource access request from a user (701). As described above, the resource access request may include a user ID, a subtenant ID, a tenant ID, a resource identifier, an action to be performed on the identified resource, and/or data associated with the action. For example, the user API 510 may parse the resource access request and forward the individual components of the request to the RBMP 520. For some embodiments, the user API 510 may modify the information included with the resource access request to cohere with a uniform standard that may be interpreted by the HRBAC 500.

The HRBAC 500 may then map the user ID to a corresponding Pgroup (702). For example, the RBMP 520 may select one of the Pgroups 532-534 that is associated with the particular user ID. As described above, with respect to FIG. 5, each Pgroup 532 and 534 is associated with one or more permissions 542-544 and 546-548, respectively. Furthermore, each of the permissions 542-548 specifies a number of actions that the associated user ID (or role) is authorized to perform on a corresponding resource (e.g., resources 552-558, respectively).

The HRBAC 500 may search the permissions associated with the selected Pgroup to determine whether the requested action is available (703). For example, if the user requests to POST data to “San Francisco,” and the user ID maps to Pgroup 532, the HRBAC 500 may search permissions 542 and 544 for authorization to perform a POST operation. If one or more permissions associated with the selected Pgroup authorize the requested action, the HRBAC 500 then determines whether such authorization is given for the desired resource (704). For example, if the permission 542 includes authorization for the requested POST operation, the HRBAC 500 may determine whether the resource 552 corresponds to “San Francisco.” If the requested action is authorized to be performed on the desired resource (704), the HRBAC 500 may notify the gatekeeper 120 to enable the user to perform the requested action on the desired resource (710). Otherwise, the HRBAC 500 may proceed to determine whether the requested action is authorized for a parent resource (705). As described above, a parent resource may be any resource that falls within a hierarchical lineage for the desired resource and belongs to a higher level of the hierarchy. For example, the HRBAC may subsequently determine whether the resource 552 corresponds to either “CA,” “USA,” or “Directory.” If the requested action is authorized to be performed on a parent resource (705), the HRBAC 500 may notify the gatekeeper 120 to enable the user to perform the requested action on the desired resource (710).

If the user is not authorized to perform the requested action on the desired resource (704) or a parent resource (705), or if the user is simply not authorized to perform the requested action at all (703), the HRBAC 500 may determine whether a search has been performed using the subtenant ID (706). If no search has been performed using the subtenant ID (706), the HRBAC may subsequently map the subtenant ID to a new Pgroup (708). For example, the RBMP 520 may select one of the Pgroups 532-534 that is associated with the particular subtenant ID. The HRBAC 500 may then repeat the search operation (703-705) described above to determine whether the user is authorized to perform the requested action on the desired resource, based on the subtenant ID.

If the user is not authorized to perform the requested action on the desired resource (704) or a parent resource (705), or the user is not authorized to perform the requested action at all (703), and a search has already been performed using the subtenant ID (706), the HRBAC may then determine whether a search has been performed using the tenant ID (707). If no search has been performed using the tenant ID (707), the HRBAC may subsequently map the tenant ID to a new Pgroup (709). For example, the RBMP 520 may select one of the Pgroups 532-534 that is associated with the particular tenant ID. The HRBAC 500 may then repeat the search operation (703-705) described above to determine whether the user is authorized to perform the requested action on the desired resource, based on the tenant ID.

Computer System

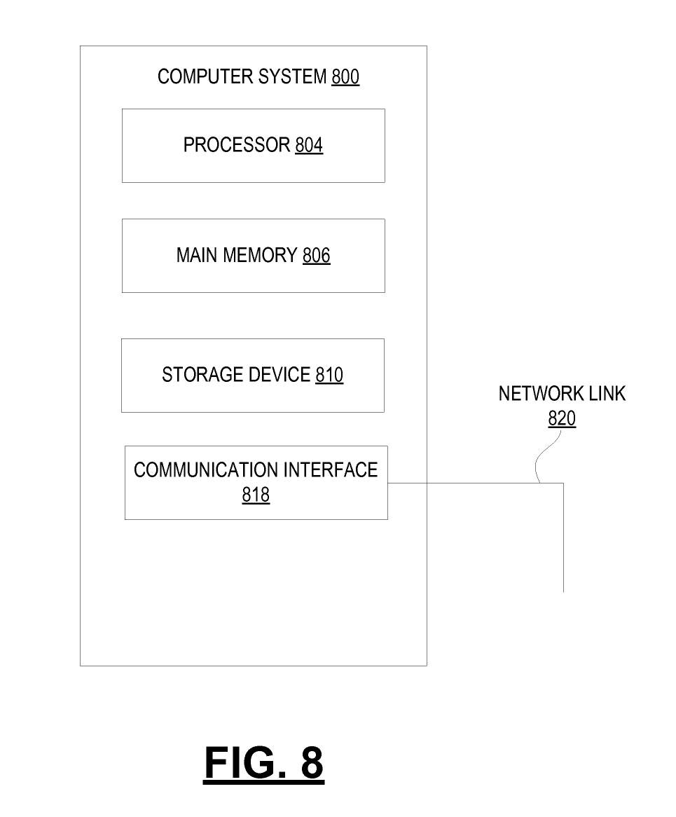

FIG. 8 is a block diagram that illustrates a computer system upon which embodiments described herein may be implemented. For example, in the context of FIG. 1, system 100 may be implemented using one or more servers such as described by FIG. 8.

In an embodiment, computer system 800 includes processor 804, memory 806 (including non-transitory memory), storage device 810, and communication interface 818. Computer system 800 includes at least one processor 804 for processing information. Computer system 800 also includes the main memory 806, such as a random access memory (RAM) or other dynamic storage device, for storing information and instructions to be executed by processor 804. Main memory 806 also may be used for storing temporary variables or other intermediate information during execution of instructions to be executed by processor 804. Computer system 800 may also include a read only memory (ROM) or other static storage device for storing static information and instructions for processor 804. The storage device 810, such as a magnetic disk or optical disk, is provided for storing information and instructions. The communication interface 818 may enable the computer system 800 to communicate with one or more networks through use of the network link 820 (wireless or wired line). The communication interface 818 may communicate with users using, for example, the Internet.

Embodiments described herein are related to the use of computer system 800 for implementing the techniques described herein. According to one embodiment, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method of providing access to resources arranged in a hierarchy, the method comprising:
receiving a request from a user to access a particular resource, wherein the request includes user identification information;
identifying a set of permissions for the user based on the user identification information, wherein each permission in the set is associated with a respective resource and one or more actions that the user is authorized to perform on that resource; and
determining a hierarchical lineage for the particular resource in relation to each resource associated with the set of permissions; and
determining whether the user is authorized to access the particular resource based, at least in part, on the hierarchical lineage.

2. The method of claim 1, further comprising:
denying the user access to the particular resource if none of the resources associated with the set of permissions fall within the hierarchical lineage.

3. The method of claim 1, wherein the request further specifies a desired action to be performed on the particular resource.

4. The method of claim 3, wherein determining whether the user is authorized to access the particular resource comprises:
determining whether the user is authorized to perform the desired action on the particular resource; and
enabling the user to access the particular resource upon determining that the user is authorized to perform the desired action on the particular resource.

5. The method of claim 3, wherein determining whether the user is authorized to access the particular resource comprises:
determining whether the user is authorized to perform the desired action on a parent resource, wherein the parent resource falls within the hierarchical lineage for the particular resource and belongs to a higher level of the hierarchy than the particular resource; and
enabling the user to access the particular resource upon determining that the user is authorized to perform the desired action on the parent resource.

6. The method of claim 1, wherein the user identification information includes a user identifier, a subtenant identifier, and a tenant identifier.

7. The method of claim 6, wherein identifying the set of permissions comprises:
identifying a first set of permissions based on the user identifier.

8. The method of claim 7, wherein identifying the set of permissions further comprises:
identifying a second set of permissions based on the subtenant identifier if none of the resources associated with the first set of permissions fall within the hierarchical lineage.

9. The method of claim 8, wherein identifying the set of permissions further comprises:
identifying a third set of permissions based on the tenant identifier if none of the resources associated with the first or second sets of permissions fall within the hierarchical lineage.

10. The method of claim 1, wherein the set of permissions is mapped to a plurality of users.

11. A computer system comprising:
a memory that stores instructions;
one or more processors which access instructions from the memory to perform operations including:
receive a request from a user to access a particular resource in a hierarchy of resources, wherein the request includes user identification information;
identify a set of permissions for the user based on the user identification information, wherein each permission in the set is associated with a respective resource and one or more actions that the user is authorized to perform on that resource;
determine a hierarchical lineage for the particular resource in relation to each resource associated with the set of permissions; and
determine whether the user is authorized to access the particular resource based, at least in part, on the hierarchical lineage.

12. The computer system of claim 11, wherein the memory further includes instructions that cause the one or more processors to:
deny the user access to the particular resource if none of the resources associated with the set of permissions fall within the hierarchical lineage.

13. The computer system of claim 11, wherein the request further specifies a desired action to be performed on the particular resource.

14. The computer system of claim 13, wherein the one or more processors are to determine whether the user is authorized to access the particular resource by:
determining whether the user is authorized to perform the desired action on the particular resource; and
enabling the user to access the particular resource upon determining that the user is authorized to perform the desired action on the particular resource.

15. The computer system of claim 13, wherein the one or more processors are to determine whether the user is authorized to access the particular resource by:
determining whether the user is authorized to perform the desired action on a parent resource, wherein the parent resource falls within the hierarchical lineage for the particular resource and belongs to a higher level of the hierarchy than the particular resource; and
enabling the user to access the particular resource upon determining that the user is authorized to perform the desired action on the parent resource.

16. The computer system of claim 11, wherein the user identification information includes a user identifier, a subtenant identifier, and a tenant identifier.

17. The computer system of claim 16, wherein the one or more processors are to identify the set of permissions by:
identifying a first set of permission based on the user identifier.

18. The computer system of claim 17, wherein the one or more processors are to further identify the set of permissions by:
identifying a second set of permissions based on the subtenant identifier if none of the resources associated with the first set of permissions fall within the hierarchical lineage.

19. The computer system of claim 18, wherein the one or more processors are to further identify the set of permissions by:
identifying a third set of permissions based on the tenant identifier if none of the resources associated with the first or second sets of permissions fall within the hierarchical lineage.

20. A computer-readable medium that stores instructions that, when executed by one or more processors, cause the one or more processors to perform operations comprising:
receiving a request from a user to access a particular resource, wherein the request includes user identification information;
identifying a set of permissions for the user based on the user identification information, wherein each permission in the set is associated with a respective resource and one or more actions that the user is authorized to perform on that resource; and
determining a hierarchical lineage for the particular resource in relation to each resource associated with the set of permissions; and
determining whether the user is authorized to access the particular resource based, at least in part, on the hierarchical lineage.
